(19) United States
(12) Patent Application Publication
(10) Pub. No.: US 2022/0081272 A1
(43) Pub. Date: Mar. 17, 2022

(54) Floor Jack Caddy

(71) Applicant: Gregory Litsis, Redmond, OR (US)

(72) Inventor: Gregory Litsis, Redmond, OR (US)

(21) Appl. No.: 17/163,741

(22) Filed: Feb. 1, 2021

Related U.S. Application Data
(60) Provisional application No. 63/078,970, filed on Sep. 16, 2020.

(51) Int. Cl. B66F 17/00; B66F 5/00

(52) U.S. Cl. CPC B66F 17/00; B66F 5/00

(57) ABSTRACT

The present invention relates to a floor jack support bracket which holds a floor jack in a secure position to prevent movement of the floor jack during transport or periods of non-use. The bracket includes a rigid plate which may be fastened to a floor or vehicle body and includes first, and second wheel supports which position the chassis of the floor jack in a position that is substantially perpendicular to the bracket support plate.

### CROSS-REFERENCE TO RELATED APPLICATION

The present application claims priority to, and the benefit of, U.S. Provisional Application No. 63/078,970, which was filed on Sep. 16, 2020 and is incorporated herein by reference in its entirety.

### FIELD OF THE INVENTION

The present invention relates to the field of tool accessories and holders. More specifically, the present invention is directed towards mounting brackets that are used to hold and support floor jacks that are used in raising heavy objects, such as automobiles, motorcycles, engines, and the like. In particular, the present invention relates to a mounting bracket used for holding, positioning and supporting floor jacks so as to avoid unnecessary damage to such tools or the vehicles that are transporting them when being moved to different work locations or job sites. Alternatively, the present invention may be used to provide an anchor or positioning device for the tool to allow for the establishment of a predefined and secured position to hold, carry and/or utilize the tool. Accordingly, the present specification makes specific reference thereto. However, it is to be appreciated that aspects of the present invention are equally amenable with other like applications, devices, and methods of manufacture.

### BACKGROUND OF THE INVENTION

Floor jacks are large and heavy jacking tools that are used for raising or lifting very heavy items, such as automobiles, motorcycles, engines and the like. More specifically, the floor jacks, which can weigh hundreds of pounds themselves, are used to lift vehicles, motorcycles and the like in order to allow mechanics and others engaged in servicing a vehicle or motorcycle to easily gain access underneath the vehicle or motorcycle to complete the task at hand. In addition, floor jacks can be used to provide emergency services, such as changing a tire or the like. Floor jacks have also been known to be used to aid in lifting walls and other heavy structures so that supports can be positioned thereunder, and repairs can be made to the particular structure.

Due to their size and weight, floor jacks take up considerable amount of space, and are not easily stored, particularly when placed in the back of a utility vehicle, such as a pick-up truck, service truck, tow truck, road side assistance truck, and the like. Further, if the floor jack is not properly secured in the back of the vehicle, it can slide and move around causing significant damage to the truck bed, as well as to other tools, materials, and the like which may also be in the back of the truck bed or the utility area of the vehicle or truck. In addition, attempting to remove the floor jack from the vehicle can be difficult given its size and weight, and particularly if the floor jack has moved around during transport and become entangled with other items stored in the truck bed or the like.

Therefore, there exists a long felt need in the art for an improved bracket system to hold, position and support a floor jack in or on a vehicle to prevent damage to the floor jack, the truck bed, or other tools and accessories stored in the bed. There also exists a long felt need in the art for a floor jack mounting system that can be adapted to various beds or other compartments of various vehicles, shop floors and other areas which permit the handling and storing of a floor jack or similar tool. Moreover, there is a long felt need in the art for a floor jack bracket that secures the floor jack, and that does not permit the floor jack to shift or reposition during the transportation of the same. Finally, there is a long felt need in the art for a floor jack bracket that is relatively inexpensive to manufacture, and safe and easy to install and use.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

In one embodiment, the present invention relates to a tool holder, and more particularly to a floor jack bracket that is fixable to a surface, such as a truck body or the floor of a mechanics shop or other building floor or surface, such as a parking lot, pad or ramp to properly and securely support a floor jack when the same is not in use. The floor jack bracket is preferably comprised of a generally rectangular plate, with first and second wheel holders that are designed to hold the wheels of a floor jack or the like, and prevent the floor jack from moving during transportation of the floor jack or during periods of non-use so that the floor jack does not cause unnecessary damage to the vehicle body or other areas of the building or materials in the vicinity of the floor jack during transportation.

In an exemplary embodiment of the present invention, a support bracket for a floor jack is described and comprises a generally planar plate or support plate having first and second longitudinally extending sides, and first and second transversely extending end edges. The support plate is further comprised of at least one opening for a fastener for securing the support plate to a surface, such as a truck bed. The first transversely extending edge is comprised of first and second guards or walls that extend upwardly from, and generally perpendicular to, the first and second longitudinally extending sides. Similarly, the second transversely extending edge is comprised of first and second guards or walls that extend upwardly from the first and second longitudinally extending sides. The first and second guards or walls are connected to one another by a roof element, thereby forming an open-ended enclosure that is sized and configured to receive a wheel of a floor jack.

In a further exemplary embodiment of the present invention, a floor jack positioning support is disclosed. The floor jack positioning support comprises a rigid and generally rectangular plate having first and second sides, and first and second ends. Each of the first and second ends have walls adjacent to each of the ends, and forming first and second wheel supports. The second wheel support has a panel extending between the walls, thereby forming an open-ended enclosure and the first wheel support has no panel.

In a still further exemplary embodiment of the present invention, a combination floor jack and support bracket is disclosed for use with a floor jack having a wheeled end with first and second wheels and a chassis. The combination floor jack and support bracket is comprised of a rigid plate and first and second wheel supports disposed on opposite ends of the rigid plate. Each of the first and second wheel supports are comprised of a first wall and a second wall, and the first wheel support is further comprised of a panel connecting the first and second walls. In use, the chassis of the floor jack is positioned substantially perpendicular to the direction of the rigid plate, wherein one of the first and second wheels is disposed in each of the first and second wheel supports.

In each of the manners described herein, the improved floor jack bracket system of the present invention accomplishes all of the forgoing objectives, and substantially departs from the concepts and designs of the conventional.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one potential embodiment of the floor jack supporting bracket of the present invention in accordance with the disclosed architecture and secured to a vehicle bed;

FIG. 2A illustrates a top perspective view of one potential embodiment of the floor jack supporting bracket of the present invention in accordance with the disclosed architecture and secured to a vehicle bed;

FIG. 2B illustrates a side elevational view of one potential embodiment of the floor jack supporting bracket of the present invention in accordance with the disclosed architecture and secured to a surface;

FIG. 3 illustrates a partial perspective view of one potential embodiment of the floor jack supporting bracket of the present invention in accordance with the disclosed architecture, wherein a floor jacket is secured to the floor jack supporting bracket;

FIG. 4 illustrates a top perspective view of one potential embodiment of the floor jack supporting bracket of the present invention in accordance with the disclosed architecture and secured to a vehicle bed;

FIG. 5 illustrates a top perspective view of one potential embodiment of the floor jack supporting bracket of the present invention in accordance with the disclosed architecture and secured to a vehicle bed; and

FIG. 6 illustrates a perspective view of a floor jack about to be mounted to one potential embodiment of the floor jack supporting bracket of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention or do not limit the scope of the invention. Additionally, an illustrated embodiment need not have all the aspects or advantages shown. Thus, in other embodiments, any of the features described herein from different embodiments may be combined.

As previously stated, there is a long felt need in the art for a floor jack bracket to hold, position and support a floor jack in or on a vehicle to prevent damage to the floor jack, the truck bed, or other tools and accessories stored in the bed. There is also a long felt need in the art for a floor jack mounting system that can be easily adapted to various beds or other compartments of a vehicle, a shop floor or other area, and that properly secures the floor jack without permitting the same to shift or reposition during transportation or when not in use. Finally, there is a long felt need in the art for a floor jack bracket that is relatively inexpensive to manufacture, and safe and easy to install and use.

The present invention is a support or bracket to secure a floor jack. By way of background, floor jacks are generally comprised of a chassis, a handle, a front wheeled end, and a caster wheel positioned along the back of the chassis. Floor jacks can weigh hundreds of pounds and because of their wheels, if not properly secured, they can move around when being transported in a truck or the like. Such unrestrained movement can result in the floor jack crashing into the side walls of the vehicle and/or other tools or components, thereby causing significant damage thereto. By providing a floor jack bracket that is secured to the truck bed or body or shop floor, this damage can be avoided, particularly by locking or holding the wheels in position within the support bracket or holder.

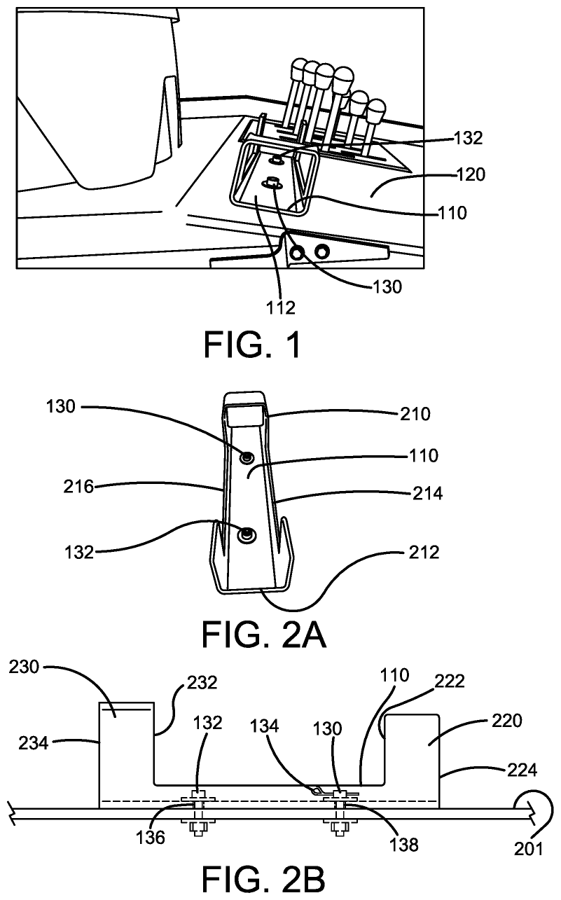

Referring now to the drawings, FIG. 1 illustrates a side perspective view of one potential embodiment of the floor jack supporting bracket 110 of the present invention in accordance with the disclosed architecture and secured to a vehicle body 120. More specifically, the floor jack supporting bracket 110 is comprised of a base plate 112 that is secured to the vehicle body 120 by at least one, and preferably two, threaded fasteners 130 which extend through a continuous opening 132 in the base plate 112. The fasteners 130 are preferably appropriately sized bolts, but may also be any other suitable fastener including, without limitation, screws, rivets, and the like. The floor jack supporting bracket 110 and its various components as described herein may be comprised of a steel, a stainless steel, a plastic, an aluminum, an alloy, or a combination thereof.

FIG. 2A illustrates a top perspective view of one potential embodiment of the floor jack supporting bracket 110 of the present invention in accordance with the disclosed architecture and secured to a vehicle body, such as a truck bed 120. More specifically, the floor jack supporting bracket 110 is further comprised of a first transversely extending end 210, a second transversely extending end 212, a first longitudinally extending side 214, and a second longitudinally extending side 216. Each of the first transversely extending end 210 and the second transversely extending end 212 are positioned on opposite ends of the base plate 112. Similarly, each of the first longitudinally extending side 214 and the second longitudinally extending side 216 are positioned on opposite sides of the base plate 112. FIG. 2A also illustrates the fasteners 130 that extend through the continuous openings 132 in the base plate 112 to secure the floor jack supporting bracket 110 to a surface, such as the truck body 120. As previously stated, the fasteners 130 are preferably threaded into the body 120, but this is not necessary. For example, the fasteners 130 may extend upwardly from the body 120 and through the continuous openings 132 in the base plate 112 where a carter pin 134 may be used to secure the floor jack supporting bracket 110 to the vehicle body 120, as best illustrated in FIG. 2B. Alternatively, the floor jack bracket support plate 110 could be welded or otherwise permanently affixed to the truck body 120.

FIG. 2B illustrates a side elevational view of one potential embodiment of the floor jack supporting bracket 110 of the present invention in accordance with the disclosed architecture and secured to a surface 201. More specifically, the surface 201 could be any sort of surface including, without limitation, a vehicle body 120, a shop floor of a mechanic's garage, a concrete or asphalt pad, such as outside of a tire store or the like to allow jacking of automobiles, a ramp for entry into a shop or garage or the like, etc.

As best illustrated in FIG. 2B, the floor jack supporting bracket 110 is further comprised of a first wheel support 220 and a second wheel support 230, wherein each of the first and second wheel supports 220, 230 are positioned on opposite ends of the base plate 112. The first wheel support 220 is further comprised of a first wall 222 and a spaced apart second wall 224. Likewise, the second wheel support 230 is further comprised of a first wall 232 and a spaced apart second wall 234. The first wall 222, 232 of each of the first and second wheel supports 220, 230 respectively is preferably comprised of a slight inward tapering (i.e., in the direction of the second wall 224, 234, respectively), wherein each of the second walls 224, 234 of each of the first and second wheel supports 220, 230, respectively is substantially vertical and perpendicular to the base plate 112. Nonetheless, it should be understood that either or both of the first or second walls may be straight or tapered.

FIG. 2B also illustrates the use of the carter pin 134 through at least one of the fasteners 130. More specifically, the fasteners 130 may extend upwardly from the surface 201 to which the floor jack supporting bracket 110 is mounted and through the continuous openings 132 in the base plate 112. The carter pin 134 may then be inserted through the fastener 130 to prevent the floor jack supporting bracket 110 from being prematurely removed from the surface 210 or vehicle body 120. Similarly, when a user (not shown) desires to remove the floor jack supporting bracket 110 from the surface 210 or vehicle body 120, he or she simply removes the carter pin 134 from the fastener 130 and lifts the bracket 110 off of the surface 210 or vehicle body 120.

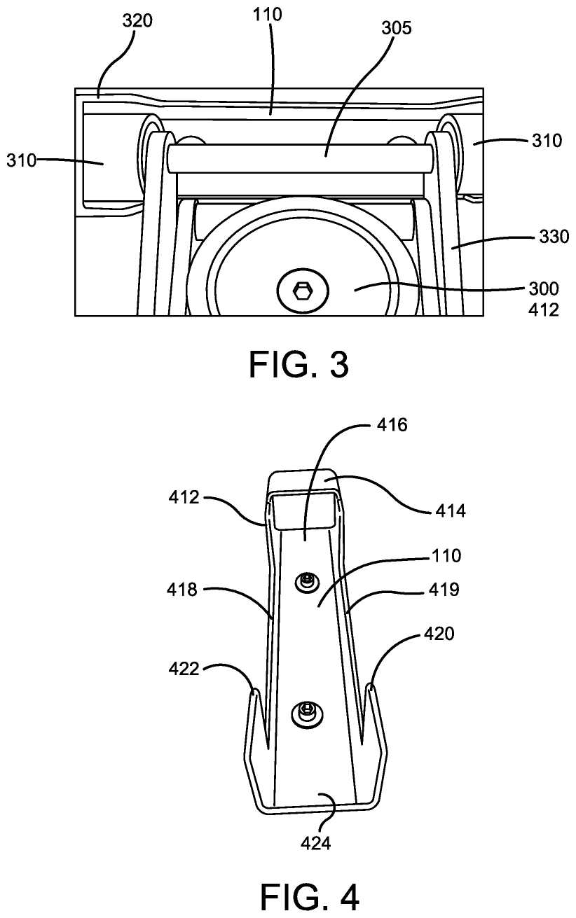

FIG. 3 illustrates a partial perspective view of one potential embodiment of the floor jack supporting bracket 110 of the present invention in accordance with the disclosed architecture, wherein a floor jack 300 is secured to the floor jack supporting bracket 110. More specifically, the floor jack 300 is comprised of a chassis 330, an axle 305 and a pair of wheels 310 rotatably positioned along said axle 305. The wheels 310 of the floor jack 300 are shown as being held in one of the wheel supports 320. The floor jack supporting bracket 110 runs generally parallel to and beneath the axle 305 supporting the wheels 310, and generally perpendicular to the chassis 330, which extends at a right angle from the axle 305. That is, the length of the floor jack 300 runs perpendicular to the bracket support 110.

FIG. 4 illustrates a top perspective view of one potential embodiment of the floor jack supporting bracket 110 of the present invention in accordance with the disclosed architecture and secured to a vehicle body 120. More specifically, the first wheel support is disposed at an end 424 of the supporting bracket 110, and is comprised of first and second walls 420, 422. Each of first and second walls 420, 422 extend generally vertically upwardly from, and perpendicular to, the base plate 112 and form an open-ended support area in the general shape of a “U”. The second wheel support is disposed at a second end 416 of the supporting bracket 110, and is comprised of first and second walls 410, 412 which are connected to one another by a panel or roof plate 414, thereby forming an open-ended enclosure. In use, one of the floor jack wheels 310 is slipped into the enclosure, and the other wheel 310 is placed in the other support. More specifically, the open-ended enclosure houses the wheel 310 and prevents the same coming out of the bracket once it is inserted, such as may be encountered during transport and/or bumpy rides. Also illustrates in FIG. 4 are the first and second ridges 418, 419 which are on the first and second longitudinally extending sides 214, 216 of the floor jack supporting bracket 110. More specifically, the ridges 418, 419 prevent the floor jack 300 from easily rolling out of the bracket assembly 110, once positioned therein.

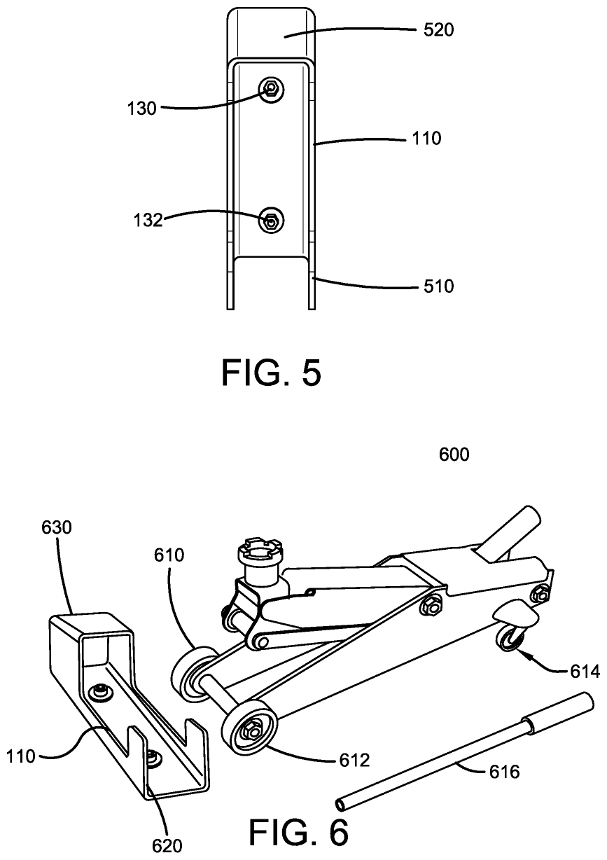

FIG. 5 illustrates a top perspective view of one potential embodiment of the floor jack supporting bracket 110 of the present invention in accordance with the disclosed architecture and secured to a vehicle body 120. More specifically, the floor jack supporting bracket 110 is shown with first and second wheel supports 510 and 520. First wheel support 510 is shown with an open top configuration, and second wheel support 520 has a closed top configuration, thereby creating the open-ended arrangement described with respect to FIG. 4 above. The floor jack supporting bracket 110 is also shown as being secured by fasteners 130 to a surface, such as the truck body 120. More specifically, the fasteners 130 extend through continuous openings 132 in the base plate 112 to secure the floor jack supporting bracket 110.

FIG. 6 illustrates a perspective view of a floor jack chassis 300 about to be mounted to one potential embodiment of the floor jack supporting bracket 110 of the present invention in accordance with the disclosed architecture. More specifically, the floor jack chassis 600 is comprised of first and second wheels 610, 612, a back caster 614 and a handle 616. The chassis 600 along with the handle has a length ranging from 49 to 62 inches, and a weight ranging from 100 to 250 pounds. The chassis 600, without the handle, has a length of between 16 and 40 inches, and a width of between 8 to 9 inches, with about 8.5 to 8.6 inches being preferred. As such, the corresponding width of the bracket 110 has about the same width as the floor jack chassis 600 to be able to accommodate the same.

Also shown in FIG. 6 is the bracket 110, which is the approximate width of the wheeled front end of the floor jack 600. The bracket is comprised of first and second wheel supports 620, 630, wherein the second wheel support 630 is comprised of a cover panel 632 to form an open-ended enclosure to allow the front end of the floor jack chassis 600 to be positioned within the bracket 110. More specifically, the open-ended enclosure, or wheel support 630, has an opening on each side having a width ranging from between 1 and 4 inches when measured from the first and second guards or walls, and a height ranging from between 1 and 4 inches when measured from the support plate 112 to the cover panel 632. The first wheel support 620 (i.e., the one without a roof panel or cover plate 632) has a width of between 1 to 4 inches as measured between the distance of the walls or guards for the wheels. The wheels have a diameter ranging from about 3 to 5 inches, a width of between 2 and 3 inches and a height of about 1 to 3 inches. Correspondingly, the internal area of the wheel supports 620 and 630 are sized and configured to hold the wheels 610, 612 of the floor jack chassis 600.

Certain terms are used throughout the following description and claims to refer to particular features or components. As one skilled in the art will appreciate, different persons may refer to the same feature or component by different names. This document does not intend to distinguish between components or features that differ in name but not in structure or function. As used herein “bracket” is interchangeable and refers to improved supports, brackets, holders or the like of the present invention.

Notwithstanding the forgoing, the floor jack bracket 110 of the present invention and its various structural components can be of any suitable size, shape, color and configuration as is known in the art without affecting the overall concept of the invention, provided that it accomplishes the above stated objectives. One of ordinary skill in the art will appreciate that the shape and size of the floor jack bracket 110 and its various components, as shown in the FIGS. are for illustrative purposes only, and that many other shapes and sizes of the floor jack bracket 110 are well within the scope of the present disclosure. Although dimensions of the floor jack bracket 110 and its various components (i.e., length, width, and height) are important design parameters for good performance, the floor jack bracket 110 and its components may be any shape or size that ensures optimal performance during use and/or that suits user need and/or preference.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A support bracket for a floor jack comprising:
a planar plate comprising a first longitudinally extending side, a second longitudinally extending side, a first transversely extending edge, a second transversely extending edge, and at least one continuous opening for receipt of a fastener for securing the planar plate to a surface;
the first transversely extending edge having a first and a second guard extending upwardly from the first and second longitudinally extending sides; and
the second transversely extending edge having a first and a second wall extending upwardly from the first and second longitudinally extending sides, wherein the first and second walls are connected to one another by a roof element forming an open-ended enclosure.

2. The support bracket for a floor jack as recited in claim 1, wherein the planar plate is comprised of a steel, a stainless steel, a plastic, an aluminum, an alloy, or a combination thereof.

3. The support bracket for a floor jack as recited in claim 1, wherein the first and second guards of the first transversely extending edge are substantially parallel to the first and second walls of the second transversely extending edge.

4. The support bracket for a floor jack as recited in claim 1, wherein the floor jack is positioned in the support bracket substantially perpendicular to the planar plate.

5. The support bracket for a floor jack as recited in claim 1, wherein each of the guards extend upwardly a distance from 1 to 4 inches.

6. The support bracket for a floor jack as recited in claim 1, wherein the roof element connecting the first and second walls has a length ranging from between 1 to 4 inches.

7. The support bracket for a floor jack as recited in claim 1, wherein the open ended enclosure has an opening having a width ranging from between 1 and 4 inches when measured from the first and second walls and a height ranging from between 1 and 4 inches when measured from the planar plate to the roof element.

8. The support bracket for a floor jack as recited in claim 1, wherein the open ended enclosure is sized and configured to house a wheel of the floor jack.

9. The support bracket for a floor jack as recited in claim 1, wherein each of the first and second guards have a first and a second edge, and further wherein at least one of the first and second edges has a taper.

10. The support bracket for a floor jack as recited in claim 1, wherein each of the first and second longitudinally extending sides have a ridge extending upwardly from the planar plate.

11. A floor jack positioning support comprising:
a rigid rectangular plate comprised of a first side, a second side, a first end and a second end, wherein each of the first and second ends are comprised of a wall that forms a first and a second wheel support; and
the second wheel support is comprised of a panel extending between the walls to form an open-ended enclosure.

12. The floor jack positioning support as recited in claim 11, wherein the rigid rectangular plate has at least one opening therein for receipt of a fastener.

13. The floor jack positioning support as recited in claim 11, wherein a floor jack is positioned in the floor jack positioning support substantially perpendicular to the first and second sides of the rigid rectangular plate.

14. The floor jack positioning support as recited in claim 13, wherein a wheeled end of the floor jack is posited within the first and second wheel supports.

15. The floor jack positioning support as recited in claim 11, wherein the rigid rectangular plate is secured to one of a truck bed, a building floor, or a surface of a vehicle via at least one fastener.

16. The floor jack positioning support as recited in claim 11, wherein each of the first and second sides have a raised ridge running between the first and second ends.

17. The floor jack positioning support as recited in claim 11, wherein the rigid rectangular support is comprised of a steel, a stainless steel, a plastic, an aluminum, an alloy, or a combination thereof.

18. A combination floor jack and support bracket comprising:
a floor jack comprised of a chassis and a wheeled end having a first and a second wheel;
a support bracket comprising a first wheel support and a second wheel support disposed on opposite ends of a rigid plate, wherein each of the first and the second wheel supports are comprised of a first wall and a second wall, and further wherein the first wheel support has a panel connecting the first and second walls of the first wheel support; and
wherein the chassis of the floor jack is positioned perpendicularly to a direction of the rigid plate with one of the first and second wheels disposed in each of the first and second wheel supports.

19. The combination floor jack and support bracket as recited in claim 18, wherein each of the first and second wheel supports have a width ranging from between 1 and 4 inches and a height ranging from between 1 and 4 inches.

20. The combination floor jack and support bracket as recited in claim 18, wherein the rigid plate has a plurality of openings therein for receipt of a plurality of fasteners.
